(19) United States
(12) Patent Application Publication
(10) Pub. No.: US 2005/0258167 A1
(43) Pub. Date: Nov. 24, 2005

(54) Electrical heating device

(76) Inventors: Tony Cheng, Nan-Tou Hsien (TW); Chi-Liang Chien, Nan-Tou Hsien (TW)

Correspondence Address: BAKER & DANIELS LLP;111 E. WAYNE STREET, SUITE 800, FORT WAYNE, IN, 46802, US

(21) Appl. No.: 10/852,039

(22) Filed: May 24, 2004

(51) Int. Cl. H05B 3/16

(52) U.S. Cl. 219/543

(57) ABSTRACT

An electrical heating device includes a heat-conducting substrate, and a resistive layer formed on the substrate and made from an Ag/Pd-containing resistive paste that comprises Ag, Pd, glass powder, and a binder. The Ag/Pd-containing resistive paste contains a volume ratio Ag/Pd of 4/5 to 7/9 so as to have a TCR less than 50 ppm/° C. in a temperature range of from room temperature to about 300° C. Spaced apart first and second electrode pads are connected electrically to the resistive layer. A first insulating layer encapsulates the resistive layer.

### BACKGROUND OF THE INVENTION

1. Field of the Invention

This invention relates to an electrical heating device, more particularly to an electrical heating device with a resistive layer made from an Ag/Pd-containing resistive paste having a composition that exhibits a low temperature coefficient of resistance.

2. Description of the Related Art

Conventional thick-film electrical heating devices, such as, cooking devices, normally include a substrate and a resistive paste formed on the substrate using screen printing techniques. Two conventional resistive pastes, i.e., Ag-containing resistive paste and RuO₂-containing resistive paste, have been proposed heretofore for application in the thick-film electrical heating devices.

The Ag-containing resistive paste has a power rating of about 300 W/in², and a temperature coefficient of resistance (TCR) greater than 200×10 ⁻⁶/° C. (ppm/° C.), which is relatively high and which can results in undesired change in the power rating of the paste, which, in turn, results in unstable heating. In addition, the resistance of the Ag-containing resistive paste tends to change considerably after a secondary sintering (the sintering temperature is above 850° C.) during manufacturing of the paste, which results in a decrease in the production yield.

The RuO₂-containing resistive paste has a power rating of about 100 W/in², and a temperature coefficient of resistance (TCR) ranging from 100-200 ppm/° C. which is also too high to provide a stable heating. Due to a much lower power rating than that of the Ag-containing resistive paste, a much larger area to be coated with the paste is required for the RuO₂-containing resistive paste than that of the Ag-containing resistive paste to provide the same amount of power. Moreover, the resistance of the RuO₂-containing resistive paste also changes considerably after secondary sintering of the paste.

U.S. Pat. No. 6,617,551 discloses a heater element of a heater that contains an alloy of Ag—Pd having a weight ratio Ag/Pd of 90/10 to 70/30 or a volume ratio of 10.3/1 to 2.7/1. The TCR of the aforesaid heater element is designed from 200 to about 1000 ppm/° C. so that heat-up speed is suppressed when the temperature control circuit of the heater becomes abnormal. The TCR of the aforesaid heater element is too high, has the same drawback as that of the aforesaid Ag- and Ruo₂-containing resistive paste, and is not suitable for use in the cooking devices which require a low TCR and a stable power rating.

The entire disclosure of U.S. Pat. No. 6,617,551 is hereby incorporated herein by reference.

### SUMMARY OF THE INVENTION

The object of the present invention is to provide an electrical heating device having a resistive layer made from an Ag/Pd-containing resistive paste with a composition that is capable of overcoming the aforesaid drawbacks of the prior art.

According to this invention, an electrical heating device comprises: a heat-conducting substrate; a resistive layer formed on the substrate and made from an Ag/Pd-containing resistive paste that comprises Ag, Pd, glass powder, and a binder, the Ag/Pd-containing resistive paste containing a volume ratio Ag/Pd of 4/5 to 7/9 so as to have a TCR less than 50 ppm/° C. in a temperature range of from room temperature to about 300° C.; spaced apart first and second electrode pads connected electrically to the resistive layer; and a first insulating layer encapsulating the resistive layer.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of the first preferred embodiment of an electrical heating device according to this invention; and

FIG. 2 is a schematic view of the second preferred embodiment of the electrical heating device according to this invention.

### DETAILED DESCRIPTION OF THE PREFERRED EMBODIMENTS

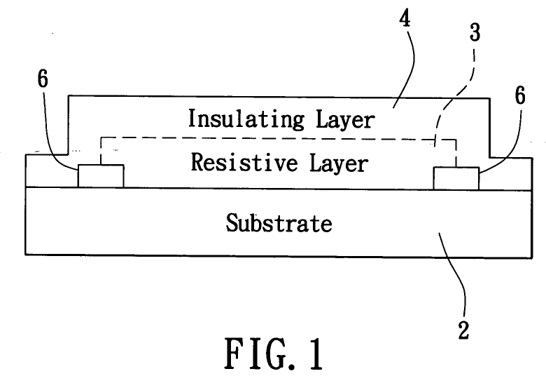

FIG. 1 illustrates the first preferred embodiment of an electrical heating device according to this invention for applications, such as electrical pots, electrical kettles, irons, welding torches, and tin soldering hot plates.

The electrical heating device includes: a heat-conducting substrate 2; a resistive layer 3 formed on the substrate 2 and made from an Ag/Pd-containing resistive paste that comprises Ag, Pd, glass powder, and a binder, the Ag/Pd-containing resistive paste containing a volume ratio Ag/Pd of 4/5 to 7/9 so as to have a TCR less than 50 ppm/° C, a resistance ranging from 0.1 to 15 Ohm/square in a temperature range of from room temperature to about 300° C., and a power rating more than 200 W/in² in a temperature range of from room temperature to about 300° C.; spaced apart first and second electrode pads 6 connected electrically to the resistive layer 3; and a first insulating layer 4 encapsulating the resistive layer 3.

In this embodiment, the glass powder comprises silicone dioxide, borosilicate, and zinc oxide. The binder is preferably cellulose type adhesive. The Ag/Pd resistive paste contains about 20-35 vol. % of silver, 25-45 vol. % of palladium, 5-25 vol. % of glass powder, 5-10 vol. % of binder, and 10-25 vol. % of a solvent.

Preferably, the resistive layer 3 has a thickness ranging from 5 to 25 μm. The substrate 2 is preferably made from a ceramic material. More preferably, the substrate 2 is made from aluminum oxide. The first insulating layer 4 is preferably made from glass. The first insulating layer 4 preferably has a thickness ranging from 5 to 25 μm.

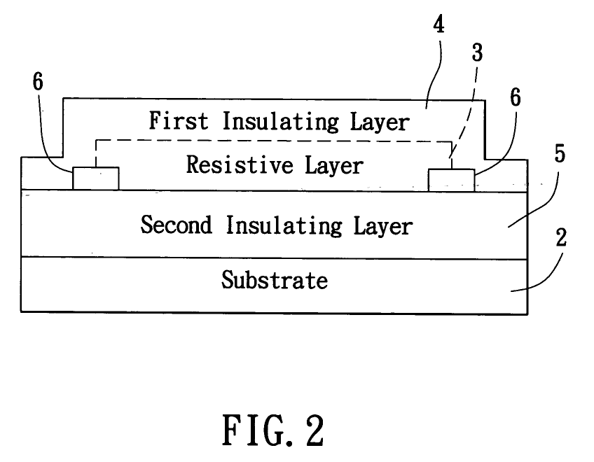

FIG. 2 illustrates the second preferred embodiment of the electrical heating device according to this invention. The electrical heating device of this embodiment is similar to the previous embodiment, except that a second insulating layer 5 is sandwiched between the substrate 2 and the resistive layer 3 and that the substrate 2 is made from stainless steel. Preferably, the second insulating layer 5 is made from glass, and has a thickness ranging from 50 to 100 μm.

The present invention will now be described in greater detail with reference to the following Examples.

### EXAMPLES 1-10

The volume ratio of silver, palladium, the glass powder, the binder, and the solvent in the Ag/Pd-containing resistive paste for forming the resistive layer 3 is 27:34:10:5:24. The resistive layer 3 of the electrical heating device of each of Examples 1-10 has a thickness of 15 μm. The substrate 2 and the first insulating layer 4 are respectively made from aluminum oxide and glass. The first insulating layer 4 has a thickness of 15 μm. After screen printing of the Ag/Pd-containing resistive paste on the substrate 2, the resistive layer 3 was subjected to a primary sintering and a secondary sintering. Each of the primary sintering and the secondary sintering was conducted by raising the temperature of the resistive layer 3 from room temperature to a sintering temperature of about 850° C. in a rate of about 55° C./min, maintaining the sintering temperature for about 10 minutes, and cooling the temperature of the resistive layer 3 from the sintering temperature to room temperature in a rate of about 50° C./min.

Table 1 shows the resistance and the TCR of each of the resistive layer of Examples 1-10.

TABLE 1

| | Resistance, Ohm | | |
|---|---|---|---|
| Example | 25° C. | 290° C. | TCR, ×10⁻⁶/° C. |
| 1 | 10.789 | 10.898 | 38.12 |
| 2 | 10.777 | 10.878 | 35.3 |
| 3 | 10.832 | 10.930 | 34.1 |
| 4 | 10.484 | 10.520 | 12.9 |
| 5 | 10.355 | 10.398 | 15.67 |
| 6 | 10.478 | 10.520 | 15.13 |
| 7 | 10.629 | 10.637 | 2.84 |
| 8 | 10.658 | 10.667 | 3.19 |
| 9 | 10.148 | 10.223 | 27.8 |
| 10 | 10.658 | 10.668 | 3.54 |

The results show that the TCR for each of Examples 1-10 is less than 50×10⁻⁶/° C. in the temperature range of from room temperature to 290° C., which is considerably lower than those of the aforesaid conventional electrical heating devices.

With the volume ratio Ag/Pd of 4/5 to 7/9 in the Ag/Pd-containing resistive paste in the electrical heating device of this invention, the aforesaid drawbacks associated with the prior art can be obviated.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. An electrical heating device comprising:
a heat-conducting substrate;
a resistive layer formed on said substrate and made from an Ag/Pd-containing resistive paste that comprises Ag, Pd, glass powder, and a binder, said Ag/Pd-containing resistive paste containing a volume ratio Ag/Pd of 4/5 to 7/9 so as to have a TCR less than 50 ppm/° C. in a temperature range of from room temperature to about 300° C.;
spaced apart first and second electrode pads connected electrically to said resistive layer; and
a first insulating layer encapsulating said resistive layer.

2. The electrical heating device of claim 1, wherein said Ag/Pd-containing resistive paste has a resistance ranging from 0.1 to 15 Ohm/square in a temperature range of from room temperature to about 300° C.

3. The electrical heating device of claim 1, wherein said resistive layer has a thickness ranging from 5 to 25 μm.

4. The electrical heating device of claim 1, wherein said substrate is made from a ceramic material.

5. The electrical heating device of claim 4, wherein said substrate is made from aluminum oxide.

6. The electrical heating device of claim 5, wherein said first insulating layer is made from glass.

7. The electrical heating device of claim 6, wherein said first insulating layer has a thickness ranging from 5 to 25 μm.

8. The electrical heating device of claim 1, further comprising a second insulating layer sandwiched between said substrate and said resistive layer.

9. The electrical heating device of claim 8, wherein said substrate is made from stainless steel.

10. The electrical heating device of claim 9, wherein said second insulating layer is made from glass.

11. The electrical heating device of claim 10, wherein said second insulating layer has a thickness ranging from 50 to 100 μm.
